(19) United States
(12) Patent Application Publication
(10) Pub. No.: US 2019/0209992 A1
(43) Pub. Date: Jul. 11, 2019

(54) PROCESS AND SYSTEM FOR THE UNIFORM DISTRIBUTION OF LIQUID ORGANIC SUBSTANCE IN THE FORM OF A THIN LAYER INTO A FALLING FILM REACTOR

(71) Applicant: DESMET BALLESTRA S.P.A., Milano (Ml) (IT)

(72) Inventors: Giuseppe DI CARPEGNA, Milano (MI) (IT); Luigi PERANI, Milano (MI) (IT)

(21) Appl. No.: 16/093,079

(22) PCT Filed: Apr. 14, 2017
(86) PCT No.: PCT/IB2017/052175

§ 371 Date: Oct. 11, 2018

(30) Foreign Application Priority Data
Apr. 15, 2016 (IT) UA2016A002647

(51) Int. Cl. B01J 10/02; B01J 19/24; B01J 4/00

(52) U.S. Cl. CPC B01J 10/02; B01J 19/2425; B01J 19/247; B01J 4/001; C07B 45/02; B01J 2219/00038; B01J 2219/0072; B01J 2219/3221; B01J 2219/00033

(57) ABSTRACT

System and process for uniform distribution of liquid organic substance in thin layer form in a falling film reactor, defined by a plurality of tubes. It is contemplated to feed the same amount of liquid organic substance to all tubes and then distribute it uniformly as a thin layer on the perimeter of each tube and by two coupled plates and sheet interposed therebetween; the lower plate is machined to create a groove and a spillway around each hole, a slit of constant thickness.

### SCOPE OF THE INVENTION

The present invention relates to the field of sulfonation systems and processes. In detail, it relates to a sulfonation reactor which is the core of the system.

### PRIOR ART

In a sulfonation process, the excellent distribution of reactants, i.e. the organic substance to be sulfonated and the sulfonating agent SO3 guarantees a correct molar ratio of reaction and the consequent high yield of mono-sulfonate product, excellent product quality and minimization of the formation of any secondary products.

Below are the basic concepts related to the sulfonation process and the technical improvements of the present invention to the organic substance distribution system within the sulfonation reactor plates.

Sulfonation involves the addition of sulfur trioxide, briefly SO3, to an organic substance to make it soluble in water. The sulfonated product that generally gives the best performance is that where a single molecule of SO3 reacts with a molecule of organic substance to produce a mono-sulfonate product. SO3 reacts with the organic substances in any ratio. Reactants must therefore be placed in contact with each other in order to obtain a mono-sulfonate product.

The sulfonation reaction is highly exothermic and while it progresses, the reaction heat must be removed quickly and effectively to prevent too high temperature rises, damaging the quality of the product. The device that best meets these needs is the “falling film reactor”.

### DESCRIPTION AND ADVANTAGES OF THE INVENTION

One object of the present invention is to provide an improved process and system for the uniform distribution of liquid organic substance in the form of a thin layer into a falling film reactor with a simple, rational and rather cost-effective solution.

These and other objects are achieved with the features of the invention described in the independent claim 1. The dependent claims describe preferred and/or particularly advantageous aspects of the invention.

In particular, an embodiment of the present invention provides a distribution system of an organic substance in a sulfonation process in a falling film reactor defined by a plurality of tubes with parallel walls; the system is defined by two coupled plates and a sheet interposed between the two; the plates are provided with a hole at each tube, having the same diameter as the interior of the tubes; the bottom plate is machined so as to create a groove and a spillway, a slot of constant thickness, around each hole.

This solution it allows effectively feeding a layer of film to each tube.

Another aspect of the invention is to provide the feeding of the organic substance to the grooves through channels formed into the thickness of the plate and through a connection hole for each groove.

With this solution, the amount fed to the various tubes is perfectly the same.

Another object of the invention is the process for the uniform distribution of liquid organic substance in the form of a thin layer into a falling film reactor, the latter defined by a plurality of tubes; it provides for feeding the same amount of liquid organic substance in all the tubes and then uniformly distributing it as a thin layer on the perimeter of each tube.

Specifically, feeding the organic substance to the grooves which in turn provide for feeding the entire circumference of all tubes.

Advantages:
High precision of distribution; the arrangement of the distribution as better described hereinafter ensures a high degree of conversion and product quality;
Permanent calibration; this means that with such a distribution of the channel and a connection hole for each groove, the reactor never requires calibration;
Minimum product hold-up, i.e. this favors the product change;
Removable distributor, which can be removed for repair without having to replace the tubes;
Tubes welded to the tube bundles which prevent potential losses of water in the product.

Said objects and advantages are all achieved by the system and process for the uniform distribution of liquid organic substance in the form of a thin layer into a falling film reactor thus made, object of the present invention, which is characterized by the appended claims.

### BRIEF DESCRIPTION OF THE FIGURES

This and other features will become more apparent from the following description of some of the configurations, illustrated purely by way of example in the accompanying drawings.

FIG. 1: shows a section of the upper portion of the falling film reactor, object of the invention,

FIG. 2: top view of FIG. 1.

### GENERAL DESCRIPTION OF FALLING FILM REACTOR

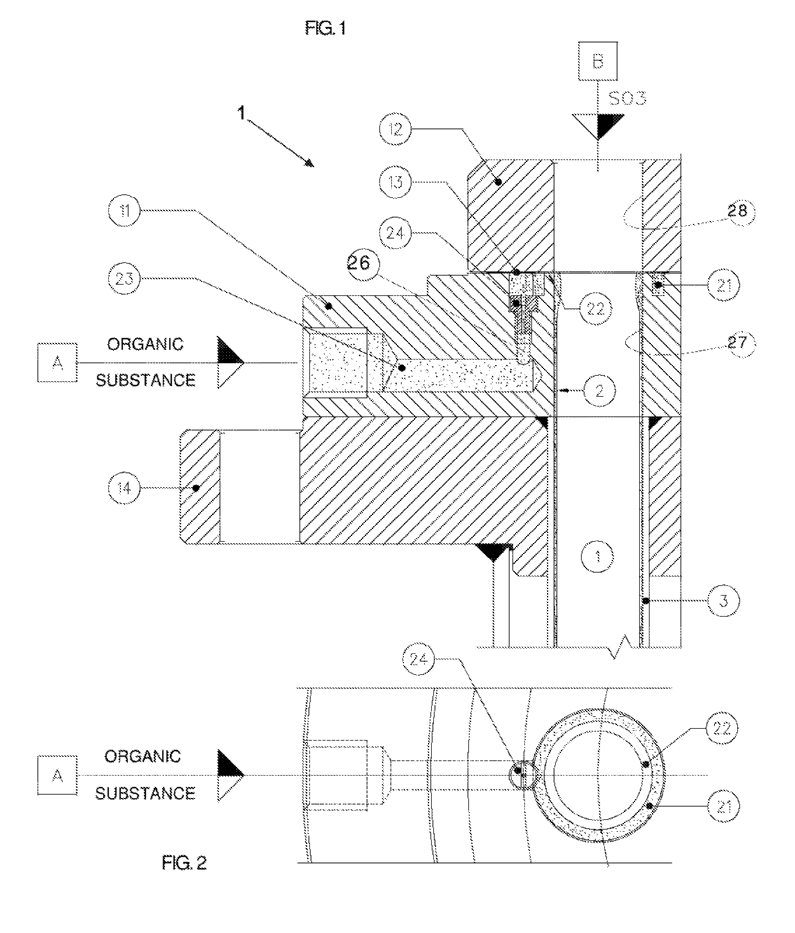

With particular reference to FIG. 1, reference numeral 10 indicates as a whole a falling film reactor for a sulfonation process.

Reactor 10 is a vertical apparatus that contains one or more reaction chambers of different shape and size.

In this case, the object of the present description, the chambers are vertical and parallel-walled tubes 1 of a tube bundle exchanger.

Reactants are fed in equi-current in the upper end of the tubes, and precisely:
the organic substance coming from A in the figure is distributed as a thin layer on the inner wall 2 of the tubes, as better described hereinafter, in input according to a direction perpendicular to the axis of tube 1;
the gaseous stream of sulfuric anhydride SO3 in the air inside the tubes and along the axis of the latter.

The outer surface 3 of tubes 1 is water cooled.

The number of tubes 1 is determined as a function of the total capacity required and the capacity of a single tube.

The distribution of reactants, organic substance and gaseous reagent SO3/air to all the reaction tubes is carried out by means of a system consisting of two plates, indicated with reference numeral 11 and 12 of which 11 is arranged underneath plate 12.

Said plates 11, 12 are common to all tubes 1, and are joined pack-like to form a “cartridge” in turn coupled to the top of the body of the reaction exchanger 14.

The uniform distribution of the reagent gas to all tubes 1 is ensured by sizing the reaction tubes 1 so as to create a pressure drop along tubes 1 sufficient to ensure that the gas is shared in equal amounts to all tubes 1.

The process provides for the uniform distribution of the liquid organic substance in the form of a thin layer (film) on the inner walls of tube 1; to this end, the process provides for feeding the same amount of liquid organic substance in all tubes 1 and then uniformly distributing it as a thin layer on the perimeter of each tube 1.

### DESCRIPTION OF THE ORGANIC SUBSTANCE DISTRIBUTION SYSTEM

In detail, the organic substance distribution system consists of the two coupled plates 11 and 12 and a sheet 13 interposed between the two.

The coupling surface of the plates if mechanically ground so that it is perfectly flat.

Plates 11, 12 are provided at each tube 1 with a hole 27 and 28 with the same diameter of the inside of tubes 1.

The bottom plate 11 is machined to create a groove 21 around each hole 27.

Preferably, sheet 13 interposed between plates 11, 12 is also provided with holes at each tube 1; said holes have a larger in diameter than the inner diameter of groove 21 so as to define a constant thickness circular slit referred to as spillway 22.

Said spillway 22 places each groove 21 in communication with the corresponding hole 27.

A slit is thus formed all around each hole and all holes 27 having constant thickness, where said thickness of spillway 22 is given by the thickness of sheet 13.

Sheet 13 is preferably made of steel and even more preferably AISI 316 or AISI 304.

According to a preferred embodiment, sheet 13 has a thickness smaller than 0.5 mm and has even more preferably of between 0.1 and 0.5 mm.

A possible embodiment contemplates to make spillway 22 by machining the lower plate 11.

The organic substance is fed to grooves 21 which feed the entire circumference of all tubes 1. The organic substance is therefore distributed with a constant thickness on the entire the surface of all tubes 1.

The organic substance is fed to grooves 21 through channels 23 formed in the thickness of the plate and through connection holes 26. If each of these holes fed a different number of tubes 1, the amount fed to the various tubes 1 may not be perfectly equal.

For this reason, the connection from channels 23 to grooves 21 is carried out by means of a hole 26 for each groove 21.

Said hole 26 has an orifice 24 having such a section as to generate a high load loss.

The distribution system of the organic substance does not require calibration to ensure the perfect distribution to all tubes 1 and remains permanently calibrated because:
All orifices 24 are calibrated at the workshop in order to guarantee the same flow rate,
Orifices 24 are all calibrated and are formed in plates 11 that are common to all tubes 1,
plates 11 are mechanically machined with great precision,
spillways 22 creating formation slits of the thin layer are formed by the interposition of sheet 13 between plates 11 and 12.

1. A process for the uniform distribution of liquid organic substance in the form of a thin layer into a falling film reactor, the latter defined by a plurality of tubes; wherein it provides for feeding the same amount of liquid organic substance in all the tubes and then uniformly distributing it as a thin layer on the perimeter of each tube.

2. The process according to claim 1, wherein it provides for feeding the organic substance into grooves each of which in turn provides for feeding the entire circumference of each tube

3. The process according to claim 1, wherein it is provided to transfer the organic substance from the groove to the tube passing through a slit of constant thickness smaller than 0.5 mm.

4. A distribution system of an organic substance in a sulfonation process in a falling film reactor defined by a plurality of tubes, wherein it comprises two coupled plates and a sheet interposed between the two; the plates are provided with a hole in correspondence to each tube, having the same diameter as the interior of the tubes; the bottom plate, is machined so as to create a groove around each hole.

5. The system according to claim 4, wherein the organic substance is fed to the grooves by means of channels formed in the thickness of the plate and through a connecting hole for each groove.

6. The system according to claim 5, wherein said hole has an orifice having a passage section of such a size as to generate a high product load loss.

7. The system according to claim 6, wherein all the orifices are calibrated so as to ensure the same flow rate.

8. The system according to claim 4, wherein the sheet is provided with a hole at each tube, having a greater diameter than the inner diameter of the groove and such as to define a spillway.

9. The system according to claim 8, wherein the spillway is defined by a circular slit of constant thickness which places each groove in communication with the corresponding hole.

10. The system according to claim 8, wherein the sheet has a thickness of between 0.1 mm and 0.5 mm.

11. The system according to claim 4, wherein the mating surface of the plates and is mechanically ground so as to be perfectly flat.

12. The system according to claim 4, wherein the spillways adapted to create thin layer formation cracks are formed into plates common to all the tubes.
